(19) United States
(12) Patent Application Publication
(10) Pub. No.: US 2006/0141294 A1
(43) Pub. Date: Jun. 29, 2006

(54) Magnetic recording medium

(75) Inventors: Yasuhiro Nishida, Miyagi (JP); Hirohisa Koga, Kanagawa (JP)

Correspondence Address: David R. Metzger;Sonnenschein Nath & Rosenthal, Wacker Drive Station, P.O. Box #061080, Chicago, IL, 60606-1080, US

(73) Assignees: Sony Corporation; Imation Corp.

(21) Appl. No.: 11/302,783

(22) Filed: Dec. 14, 2005

(30) Foreign Application Priority Data
Dec. 28, 2004 (JP) 2004-379989

(51) Int. Cl. G11B 5/706

(52) U.S. Cl. 428/845.5

(57) ABSTRACT

A magnetic tape of a linear magnetic recording system is provided that suppresses a lateral tape motion to realize a high track density. A body to be processed (magnetic tape) is allowed to travel in a prescribed direction between a supply roll and a winding troll through guide rolls at a speed, for instance, 400 m/minute. Then, a grinding and polishing tape (lapping tape) using an abrasive material having a particle diameter of 9 μm is moved to a direction the same as the above-described direction between a supply roll and a winding roll through a pressing roll at a speed, for instance, 14.4 cm/minute. The pressing roll presses the surface of a back coat layer side of the body to be processed by a guide block from an upper part to allow the grinding and polishing tape to come into contact with the surface of the back coat layer of the tape. Thus, a grinding and polishing (lapping) process is carried out to form a texture on the back coat layer.

### CROSS REFERENCES TO RELATED APPLICATIONS

The present invention contains subject matter related to Japanese Patent Application JP 2004-379989 filed in the Japanese Patent Office on Dec. 28, 2004, the entire contents of which being incorporated herein by reference.

### BACKGROUND OF THE INVENTION

1. Field of the Invention

The present invention relates to a magnetic tape advantageously used especially for recording computer data. More particularly, the present invention relates to a magnetic recording medium for high density recording that meets a magnetoresistive head (MR head) and a giant magnetoresistive head (GMR head)

2. Description of the Related Art

In recent years, in a magnetic recording and reproducing system for recording and reproducing computer data, a system in which a thin film magnetic head incorporated has been put to practical use. Since the thin film magnetic head can be easily miniaturized or processed to a multi-track head, many multi-track fixed heads of the thin film magnetic head have been used especially in systems employing the magnetic tapes as recording media. The use of the thin film magnetic head makes it possible to improve a track density or a recording efficiency due to a miniaturization, to realize a high density recording and to improve the transfer speed of data due to the formation of multi-tracks.

The thin film magnetic head can be roughly classified into an inductive head responding to a change in time of a magnetic flux and a magnetoresistive head (MR head) using a magnetoresistive effect responding to the intensity of a magnetic flux. Since the inductive head has a plane structure, the number of windings of a head coil is small. Thus, a magnetomotive force is hardly increased, so that a sufficient reproducing output cannot be undesirably obtained. Therefore, the MR head from which a high reproducing output is easily obtained is used for reproduction. On the other hand, the inductive head is used for recording.

These recording and reproducing heads are ordinarily incorporated in the system as an integral type (complex type). In the magnetic recording system as described above, what is called a linear recording system that can realize a faster transfer of data is adopted.

The linear recording system means a recording system for recording/reproducing data while a tape travels in two ways on the above-described multi-track head. In the linear magnetic recording system, it is very important for improving the recording density thereof to suppress the widthwise variation of the tape (Lateral Tape Motion) LTM (sometimes refer it only to as an LTM, hereinafter) as the width of the tracks is narrowed.

The LTM cannot be completely suppressed, and accordingly, a head stack for controlling a magnetic recording/reproducing operation can be varied in the direction of width of the tape so as to follow the LTM. The frequency component and amplitude of the LTM are respectively correlated. In order to suppress the amplitude, for instance, when a tape edge is tried to be regulated by a tape guide or the like for suppressing the amplitude, a friction and the vibration of the tape caused thereby occur. For instance, when tape speed is set to 8 m/s or lower depending on the tape speed, even frequency components of 1 KHz or higher are distributed. To respond to such high frequency components, a high speed actuator is required.

On the other hand, when the tape is not regulated by the tape edge, the frequency components of the LTM are obviously lowered. However, the amplitude reaches several ten microns. Further, since the LTM depends on the form of the tape, the LTM may possibly change due to an elapsing change and the change of temperature and humidity so that the LTM exceeds a tracking capability of the actuator.

As the magnetic tape for recording computer data used in the magnetic recording and reproducing system in which the MR head is incorporated, known are, for instance, magnetic tapes meeting a 3480 type, 3490 type, 3590 type or 3570 type in accordance with the standard of IBM.

For these magnetic tapes, what is called a particulate type magnetic recording medium is used that is manufactured by applying and drying on a nonmagnetic supporter a magnetic coating material obtained by dispersing a magnetic material such as oxide magnetic powder or alloy magnetic powder in an organic binder such as a vinyl chloride-vinyl acetate polymer, a polyester resin, polyurethane resin, etc.

Since such a particulate type magnetic recording medium is requested to record data with high density, the nonmagnetic supporter is directly coated with a ferromagnetic material composed of metal or an alloy such as Co—Ni by plating, a vacuum thin film forming technique (a vacuum deposition method, a sputtering method, an ion plating method, etc.). Thus, a magnetic recording medium having a magnetic layer made of a ferromagnetic metallic thin film is produced and put to practical use.

The so-called metallic thin film type magnetic recording medium as described above has various advantages. That is, the magnetic recording medium is not only excellent in its coercive force, residual magnetization, an angular ratio and an electromagnetic transfer characteristics in short wavelength, but also the thickness of the magnetic layer can be greatly reduced. Therefore, the thickness loss during a reproducing and a recording demagnetization are low. Further, since the binder as the nonmagnetic material does not need to be mixed in the magnetic layer, the charging density of the magnetic material can be improved and a large magnetization can be obtained.

Further, to improve the electromagnetic transfer characteristics of such kind of magnetic recording medium and obtain a larger output, what is called an oblique deposition is proposed in which the magnetic layer is obliquely deposited when the magnetic layer of the magnetic recording medium is formed. This magnetic recording medium is put to practical use as a magnetic tape for a VTR of high image quality and a magnetic tape for a digital VTR.

Japanese patent application laid-open No. 2002-216340 disclosed that a texture layer having fine irregularities is formed on the nonmagnetic supporter to make a good surface smoothness of the magnetic layer compatible with a suitable roughness of the surface of the magnetic recording medium.

Further, Japanese patent application laid-open No. 2002-222512 discloses that a texture layer having fine irregularities is formed on the surface of the magnetic layer to make a good surface smoothness of the magnetic layer compatible with a suitable roughness of the surface of the magnetic recording medium.

### SUMMARY OF THE INVENTION

As described above, in the linear magnetic recording system, it is very important for improving the recording density thereof to suppress the widthwise variation of a tape (Lateral Tape Motion) LTM as the width of tracks is narrowed.

Accordingly, it is desirable to provide a magnetic recording medium suitable for a magnetic recording and reproducing system that uses a linear recording system and has a magnetoresistive reproducing head incorporated. Particularly, it is desirable to suppress the vibration of a tape, what is called a lateral tape motion (LTM) and to thus provide a magnetic tape of high track density.

For solving the above-described problems, the inventors of the present invention eagerly studied and accordingly found that a magnetic recording medium used for what is called a linear recording system in which magnetic recording signals are reproduced in two ways with respect to a traveling direction of a medium by a reproducing head using a magnetoresistive magnetic head (MR head) or a giant magnetoresistive head (GMR head) and including: a magnetic layer on one main surface of a lengthy nonmagnetic supporter and a back coat layer including at least inorganic solid particles and a binder on the other main surface opposite to the magnetic layer forming surface, and a texture being provided on the back coat layer in parallel with the traveling direction could suppress an LTM to thus provide a magnetic tape of high track density.

Further, when a form to be transferred to the magnetic surface was considered, they found that the magnetic recording medium having the texture of depth of 15 to 400 nm was preferable.

Further, they found that the magnetic recording medium in which the cycle of the texture in the direction of width of the medium was 25 to 500 (μm) was more preferable.

For a drive of the linear magnetic recording system to which the present invention is applied, a dynamic pressure air bearing system generated by the relative speed between a tape and a moving surface of a guide is suitable that is different from a static pressure air bearing system in which a roller guide or air is supplied relative to a tape moving surface to float a tape.

In the roller guide described as the example, as the speed of the tape is increased, the rotating speed of a bearing is increased. Thus, frequency resulting from unevenness in a bearing race surface is elevated and the high positional accuracy of the roller is requested, so that a cost is raised and productivity is undesirably lowered.

In the static pressure air bearing system to which the air is externally supplied, an amount of floatation of the tape is determined on the basis of an amount of supply of the air. When the tape is completely floated form the guide, the present invention is not suitable, however, the present invention is applicable and useful to a case where a part of the surface of the tape always, or with a certain probability, comes into a part of the surface of the guide.

According to an embodiment of the present invention, in a magnetic recording medium used for what is called a linear recording system in which magnetic recording signals are reproduced in two ways with respect to a traveling direction of a medium by a reproducing head using a magnetoresistive head (MR head) or a giant magnetoresistive head (GMR head), a medium is obtained that can reduce the widthwise vibration of a tape (a lateral tape motion) LTM and provide a high track density.

### BRIEF DESCRIPTION OF THE DRAWINGS

FIG. 1 is a sectional view showing one embodiment of a magnetic recording medium to which the present invention is applied.

FIG. 2 is a structural view showing one example of a deposition device for producing the magnetic recording medium of the present invention.

FIG. 3 is a structural view showing one example of a film forming device for producing the magnetic recording medium of the present invention.

FIG. 4 is a structural view showing one example of a surface grinding and polishing device for forming a texture of the magnetic recording medium of the present invention.

FIG. 5 is an explanatory view showing a surface scanned form of the texture on a back coat layer of the magnetic recording medium of the present invention.

FIG. 6 is an explanatory view showing a surface scanned form of a surface of a guide material of a drive of the magnetic recording medium finished by a miracle turning tool.

FIG. 7 is an explanatory view showing a surface scanned form of the guide of the drive of the magnetic recording medium finished by an R turning tool.

FIG. 8 is an explanatory view showing a state of surface irregularities of the texture of the present invention.

FIG. 9 is an explanatory view showing a mechanism of the generation of a frictional force of a tape and the guide.

### DTAILED DESCRIPTION OF THE PREFERRED EMBODIMENT

Now, referring to the drawings, an embodiment of the present invention will be described below. A magnetic recording medium according to an embodiment of the present invention is used for what is called a linear recording system in which magnetic recording signals are reproduced in two ways with respect to a traveling direction of a medium by a reproducing head using a magnetoresistive head (MR head) or a giant magnetoresistive head (GMR head) and includes a magnetic layer on one main surface of a lengthy nonmagnetic supporter and a back coat layer including at least inorganic solid particles and a binder on the other main surface opposite to the magnetic layer forming surface, and a texture being provided on the back coat layer in parallel with the traveling direction.

The above-described texture may be formed by using a grinding and polishing tape or a grinding and polishing cloth after the magnetic recording layer is formed. The texture may be originally formed on the surface of the nonmagnetic supporter to which the back coat is applied. Other methods may be, of course, used. Any of the methods may be used by which a texture is consequentially formed in parallel with the traveling direction on the back coat layer.

Now, component materials of the magnetic recording medium according to an embodiment of the present invention and a method for producing the magnetic recording medium will be described in detail. The present invention is not limited to below-described embodiment.

### First Embodiment

### Particulate Type Medium

<Magnetic Layer>

Firstly, a description will be given to the component materials of the magnetic layer. A ferromagnetic material included in the magnetic layer is not especially limited to specific materials. Exemplified are ferromagnetic alloy powder, ferromagnetic hexagonal ferrite powder, ferromagnetic iron oxide particles, ferromagnetic CrO₂, ferromagnetic cobalt ferrite (CoO—Fe₂O₃), cobalt adsorbed oxide, fine particles of iron nitride, etc.

As the ferromagnetic alloy powder, usable are Fe alloy powder, Co alloy powder, Ni alloy powder, alloy powder of Fe—Co, Fe—Ni, Fe—Co—Ni, Co—Ni, Fe—Co—B, Mn—Bi, Mn—Al, Fe—Co—V or the like or alloy powder as compounds of these alloys and other elements.

Further, to improve characteristics, semi-metals such as Si, P, B, C or the like may be added to a composition. To chemically stabilize the surfaces of particles of the metal powder, an oxide layer is ordinarily formed thereon. As a method for forming oxide, exemplified are a known deoxidizing process, that is, a method for immersing the particles in an organic solvent and then drying the particles, a method for immersing the particles in the organic solvent and supplying oxygen-containing gas to form an oxide film on the surface and then drying the particles, and a method for adjusting the partial pressure of oxygen gas and inert gas without using the organic solvent to form an oxide film on the surface. The metal powder to which any of the above-described methods is applied can be employed.

The ferromagnetic hexagonal ferrite powder is ferromagnetic powder having a plate form and an easy magnetization axis vertical to the surface of the plate and includes barium ferrite, strontium ferrite, lead ferrite, calcium ferrite or cobalt substituents of them. The cobalt substituent of barium ferrite and the cobalt substituent of strontium ferrite are especially preferable among them. Further, to improve the characteristics thereof as required, elements such as In, Zn, Ge, Nb, V, etc. may be added.

In the hexagonal ferrite powder, in the case of a long wavelength recording, an output is lower than those of other particles. However, in a short wavelength recording in which the shortest recording wavelength of a high frequency band is 1.5 μm or lower, preferably, 1.0 μm or lower, a higher output than other magnetic particles can be rather anticipated.

The form of the ferromagnetic material is not limited to specific forms. A needle form, a particle form, a die form, a rice grain form and a plate form may be enumerated. In the case of the needle form, needle forms having a needle form ratio of 3/1 to 30/1 or so and 4/1 or higher are preferable. As the specific surface area of the ferromagnetic material, 40 m²/g or higher is preferable in view of electromagnetic transfer characteristics. Further, 45 m²/g or higher is preferable. Further, as the binder in the magnetic layer, usable are usually known thermoplastic resins, thermosetting resins or radiation cross-linked resins by an electron beam or the mixtures of them. As the thermoplastic resins, a thermoplastic resin having a softening temperature of 150° C. or lower, an average molecular weight of 5000 to 50000 and the degree of polymerization of about 50 to 500 is preferable.

As the thermoplastic resins, exemplified are, for instance, vinyl chloride, vinyl acetate, a vinyl chloride-vinyl acetate copolymer, a vinyl chloride-vinylidene chloride copolymer, a vinyl chloride-acrylonitrile copolymer, an acrylic ester-acrylonitrile copolymer, an acrylic ester-vinyl chloride-vinylidene chloride copolymer, an acrylic ester-vinylidene chloride copolymer, a methacrylic ester-vinylidene chloride copolymer, a methacrylic ester-vinyl chloride copolymer, a methacrylic ester-ethylene copolymer, polyvinyl fluoride, a vinylidene chloride-acrylonitrile copolymer, an acrylonitrile-butadiene copolymer, a polyamide resin, polyvinyl butyral, cellulose derivatives (cellulose acetate butylate, cellulose diacetate, cellulose triacetate, cellulose propionate, nitrocellulose), a styrene-butadiene copolymer, polyurethane resin, a polyester resin, an amino resin, synthetic rubber and mixtures of them.

Further, as examples of the thermosetting resins, a phenolic resin, an epoxy resin, a thermosetting polyurethane resin, an urea resin, a melamine resin, an alkyd resin, a silicone resin, a polyamine resin and an urea-formaldehyde resin or the like may be exemplified. Further, resins used as the binder that have in their molecules polar groups such as acid groups including —SO₃H, —OSO₃H, —PO₃H, —OPO₃H₂, —COOH, etc., salts of them or a hydroxyl group, an epoxy group, an amino group give excellent dispersing characteristics and a durability of a coat. The resins having —SO₃Na, —COOH, —OPO₃Na₂, —NH₂ etc., are most preferable among them.

In the magnetic layer of the magnetic recording medium according to an embodiment of the present invention, the inorganic particles having Mohs hardness of 5 or higher are preferably included. The inorganic particles to be used that have the Mohs hardness of 5 or higher may be used without a special limitation. As examples of the inorganic particles having the Mohs hardness of 5 or higher, Al₂O₃ (Mohs hardness of 9), TiO (Mohs hardness of 6), TiO₂ (Mohs hardness of 6.5), SiO₂ (Mohs hardness of 7), SnO₂ (Mohs hardness of 6.5), Cr₂O₃ (Mohs hardness of 9) and α-Fe₂O₃ (Mohs hardness of 5.5) may be exemplified. These particles may be independently used or mixed and the mixture may be used.

The inorganic particles having the Mohs hardness of 8 or higher are especially preferable. When the relatively soft inorganic particles having the Mohs hardness is lower than 5 are used, the inorganic particles are liable to peel off from the magnetic layer. Further, since a head grinding and polishing operation is scarcely carried out, a head is apt to be clogged and durability in traveling is deteriorated. The inorganic particle content is ordinarily preferably located within a range of 0.1 to 20 parts by weight relative to 100 parts by weight of the ferromagnetic material, more preferably within a range of 1 to 10 parts by weight.

When the coating material of the magnetic layer is prepared, an antistatic agent may be used as well as the above-described components. As examples of the antistatic agent, exemplified are conductive fine powder such as carbon black, carbon black graft polymer, etc, natural surface active agent such as saponin, nonion based surface active agents such as alkylene oxide, glycerine and glycidol, etc., cation surface active agents such as higher alkyl amines, quaternary ammonium salts, pyridine and other salts of heterocyclic compounds, phosphonium or sulfonium, anion surface active agents including acid groups such as carboxylic acid, phosphoric acid, sulfuric ester group, phosphoric ester group, amphoteric surface active agents such as amino acid, amino sulfonic acid, sulfuric acid-containing amino ester or phosphoric ester.

Further, as a lubricant internally added to the magnetic layer, fatty acid ester, fatty acid having the number of carbons of 8 to 22, fatty acid amide and aliphatic alcohol may be employed. Further, usable are silicon oil, graphite, molybdenum disulfide, boron nitride, graphite fluoride, fluorine alcohol, polyolefine (polyethylene wax, etc.), polyglycol (polyethylene oxide wax, etc.), alkyl phosphoric ester, thiophosphoric ester, polyphenyl ether, tungsten disulfide.

As specific examples of the lubricants composed of organic compounds, exemplified are, as fatty acid, capric acid, caprylic acid, lauric acid, myristic acid, palmitic acid, stearic acid, behenic acid, oleic acid, elaidic acid, linoleic acid, linolenic acid, isostearic acid, etc.

As esters, enumerated are butyl stearate, octyl stearate, amyl stearate, isooctyl stearate, butyl myristate, octyl myristate, butoxy ethyl stearate, butoxy diethyl stearate, 2-ethyl hexyl stearate, 2-octyl dodecyl palmitate, 2-hexyl dodecyl palmitate, isohexadecyl stearate, oleyl oleate, dodecyl stearate, tridecyl stearate, and as alcohol, oleyl alcohol, stearyl alcohol, lauryl alcohol, etc.

<Lower Nonmagnetic Layer>

Now, component materials of the lower nonmagnetic layer will be described below. As nonmagnetic pigments included in the lower nonmagnetic layer, for instance, α-Fe₂O₃, TiO₂, carbon black, graphite, barium sulfate, ZnS, MgCO₃, CaCO₃, ZnO, CaO, tungsten disulfide, molybdenum disulfide, boron nitride, MgO, SnO₂, Cr₂O₃, α-Al₂O₃, α-FeCOOH, SiC, cerium oxide, corundum, artificial diamond, α-iron oxide, garnet, quartzite, silicon nitride, boron nitride, silicon carbide, molybdenum carbide, boron carbide, tungsten carbide, titanium carbide, tripoli, diatom earth, dolomite, etc. Preferable are inorganic powder such as α-Fe₂O₃, TiO₂, carbon black, CaCO₃, barium sulfate, α-Al₂O₃, α-FeOOH, Cr₂O₃ or polymer powder such as polyethylene.

As a binder of the lower nonmagnetic layer, it is initially necessary to consider that the surface characteristics of the lower surface, that is, the dispersion power of the pigments of the lower layer and the uniformity of the interface of the upper and lower layers are satisfied. As the binders satisfying the above-described condition, usable are usually known thermoplastic resins, thermosetting resins or radiation cross-linked resins by an electron beam or the mixtures of them like the binders of the upper layer.

Further, as a lubricant internally added to the lower nonmagnetic layer, fatty acid ester, fatty acid having the number of carbons of 8 to 22, fatty acid amide and aliphatic alcohol may be employed. Further, usable are silicon oil, graphite, molybdenum disulfide, boron nitride, graphite fluoride, fluorine alcohol, polyolefine (polyethylene wax, etc.), polyglycol (polyethylene oxide wax, etc.), alkyl phosphoric ester, thiophosphoric ester, polyphenyl ether, tungsten disulfide.

As specific examples of the lubricants composed of organic compounds, exemplified are, as fatty acid, capric acid, caprylic acid, lauric acid, myristic acid, palmitic acid, stearic acid, behenic acid, oleic acid, elaidic acid, linoleic acid, linolenic acid, isostearic acid, etc. As esters, enumerated are butyl stearate, octyl stearate, amyl stearate, isooctyl stearate, butyl myristate, octyl myristate, butoxy ethyl stearate, butoxy diethyl stearate, 2-ethyl hexyl stearate, 2-octyl dodecyl palmitate, 2-hexyl dodecyl palmitate, isohexadecyl stearate, oleyl oleate, dodecyl stearate, tridecyl stearate, and as alcohol, oleyl alcohol, stearyl alcohol, lauryl alcohol, etc.

When a coating material of the nonmagnetic layer is prepared, an antistatic agent may be used as well as the above-described components. As examples of the antistatic agent, exemplified are conductive fine powder such as carbon black, carbon black graft polymer, etc, natural surface active agent such as saponin, nonion based surface active agents such as alkylene oxide, glycerine and glycidol, etc., cation surface active agents such as higher alkyl amines, quaternary ammonium salts, pyridine and other salts of heterocyclic compounds, phosphonium or sulfonium, anion surface active agents including acid groups such as carboxylic acid, phosphoric acid, sulfuric ester group, phosphoric ester group, amphoteric surface active agents such as amino acid, amino sulfonic acid, sulfuric acid-containing amino ester or phosphoric ester.

When the conductive fine powder is employed as the antistatic agent, the powder is used, for instance, within a range of 1 to 15 parts by weight relative to the nonmagnetic pigment of 100 parts by weight. When the surface active agent is used, it is also used within a range of 1 to 15 parts by weight.

Further, inorganic particles having Mohs hardness of 5 or higher may be included like the upper magnetic layer. As examples of the inorganic particles having the Mohs hardness of 5 or higher, Al₂O₃ (Mohs hardness of 9), TiO (Mohs hardness of 6), TiO₂ (Mohs hardness of 6.5), SiO₂ (Mohs hardness of 7), SnO₂ (Mohs hardness of 6.5), Cr₂O₃ (Mohs hardness of 9) and α-Fe₂O₃ (Mohs hardness of 5.5) may be exemplified. These particles may be independently used or mixed and the mixture may be used.

<Production of Magnetic Recording Medium>

Now, an example of a method for producing the magnetic recording medium of the present invention will be described below. The above-mentioned ferromagnetic material and the binder, and other fillers and addition agents, if necessary, are mixed and kneaded with a solvent to prepare a magnetic coating material.

As the solvent used during a kneading operation, for instance, exemplified are ketone based solvents such as acetone, methyl ethyl ketone, methyl isobutyl ketone, cyclohexanone, etc., alcohol based solvents such as methanol, ethanol, propanol, etc., ester based solvents such as methyl acetate, ethyl acetate, butyl acetate, propyl acetate, ethyl lactate, ethylene glycol acetate, ether based solvents such as diethylene glycol dimethyl ether, 2-ethoxyethanol, tetrahydrofuran, dioxane, etc., aromatic hydrocarbon based solvents such as benzene, toluene, xylene, etc., halogenated hydrocarbon based solvents such as methylene chloride, ethylene chloride, carbon tetrachloride, chloroform, chlorobenzene, etc. These materials may be suitably mixed and the mixtures may be used.

A method for kneading the materials is not limited to a specific method. In addition, a sequence of adding the components can be properly set. For preparing the magnetic coating materials, an ordinary kneading machine is used. For example, exemplified are a sand mill, a dino mill, a double cylinder pearl mill, a two roll mill, a three roll mill, a ball mill, a high speed impeller disperser, a high speed stone mill, a high speed impact mill, an extruder, a disper kneader, a high speed mixer, a homogenizer, an ultrasonic disperser, etc. As the component materials of the nonmagnetic supporter, polyesters such as polyethylene terephthalate, polyethylene naphthalate, etc., polyolefines such as polypropylene, cellulose derivatives such as cellulose triacetate, cellulose diacetate, etc, vinyl based resins such as polyvinyl chloride, plastics such as polycarbonate, polyamide, polysulfone, etc., metals such as aluminum, copper, etc., ceramics such as glass. These supporters may be subjected to a corona discharge process, a plasma process, an under-coating process, a heat treatment, a dust removing process, a metal deposition process and alkaline process before a coating process.

The coating materials may be directly applied to the nonmagnetic supporter. However, the coating materials may be applied to the nonmagnetic supporter through an adhesive layer or the like. As examples of methods for applying the coating materials to the nonmagnetic supporter, exemplified are an air doctor coating method, a blade coating method, a rod coating method, an extrusion coating method, an air knife coating method, a squeeze coating method, an impregnation coating method, a reverse roll coating method, a transfer roll coating method, a gravure coating method, a kiss coating method, a cast coating method, a spray coating method, and a spin coating method. Especially, what is called a wet-on-wet coating system may be employed that the nonmagnetic coating material for the lower layer is superimposed on the magnetic coating material for the upper layer under a wet state to apply the coating materials to the supporter.

In the simultaneous superimposed layer coating system in the wet-on-wet system, while the lower layer remains in the wet state, the upper layer is coated with the magnetic coating materials. Thus, the surface of the lower layer (namely, a boundary surface between the lower layer and the upper layer) is smoothed and the surface characteristics of the upper layer are improved. Thus, an adhesive property between the upper and lower layers is also improved. As a result, a performance required for the magnetic recording medium in which a high output and low noise are necessary due to a high density recording is satisfied. A film is not peeled off and the strength of the film is increased. Further, a drop-out can be reduced and a reliability is enhanced.

The thickness of the upper magnetic layer applied in such a way is preferably 1.5 μm or smaller, further preferably 1.0 μm or smaller and most preferably 0.5 μm or smaller. The thickness of the lower nonmagnetic layer may be suitably determined depending on the purpose of use of the medium and is frequently set to 0.5 to 3 μm. Further, the thickness of the supporter may be suitably determined depending on the purpose of use of the medium and is frequently set to 2 to 10 μm.

When the produced magnetic recording medium is employed in the form of a tape, the magnetic layer applied on the nonmagnetic supporter is subjected to a process for orienting the ferromagnetic material in the magnetic layer, that is, a magnetic field orientation process, and then dried. Further, a surface smoothing process is carried out as needed.

As to the orientation, it is preferable to control the drying position of the coated film by controlling the temperature of drying air, an air volume and an coating speed. The coating speed of 20 m/minute to 1000 m/minute and the temperature of the drying air of 60° C. or higher are preferable. A suitable preliminary drying process can be performed before entering a magnetic zone.

The surface smoothing process is carried out by using, as a roll, a heat resistant plastic roll such as epoxy, polyimide, polyamide, polyimideamide or a metallic roll. A processing temperature is preferably 50° C. or higher, and further preferably 100° C. or higher. A linear pressure is preferably 200 kg/cm or higher and further preferably 300 kg/cm or higher.

(Sample 1)

In this embodiment, a magnetic recording medium having a lower nonmagnetic layer and an upper magnetic layer formed on a nonmagnetic supporter was produced as a sample. Firstly, a magnetic coating material for forming the magnetic layer and a nonmagnetic coating material for forming the nonmagnetic layer were produced. The coating materials were respectively produced by ordinary producing methods. In both the coating materials, a pigment (ferromagnetic powder or nonmagnetic powder), a binder, an addition agent and a solvent were initially mixed together. Then, the mixture was kneaded by a kneader so that a nonvolatile component during a kneading operation was 85 wt %. After that, the magnetic coating material was dispersed for 5 hours by a sand mill and the nonmagnetic coating material was dispersed by a sand mill for 3 hours. Thus, the coating materials were respectively obtained. The components of the coating materials are respectively shown below.

<Components of magnetic coating material>

| | | |
|---|---|---|
| ferromagnetic metal powder | 100 | parts by weight |
| [composition/Fe:Co = 90:10 (atomic ratio), coercive force (Hc): 147 kA/m | | |
| (1850 oersted (Oe)), specific surface area by BET method: 58 m²/g, size of | | |
| crystallite: 175 angstrom, saturation magnetization (σs): 130 A · m²/kg (130 emu/g), | | |
| particle size (average diameter of major axis): 0.10 μm, needle form ratio: 7.0] | | |
| Polar group (—SO₃K group) containing vinyl chloride based copolymer | 12 | parts by weight |
| [amount of content of —SO₃K group: 5 × 10⁻⁶ mol/g, degree of polymerization of | | |
| 350, amount of content of epoxy group: 3.5 wt % on the basis at monomer unit | | |
| (MR-110 produced by Nippon Zeon Co., Ltd.) | | |
| Polar group (—SO₃Na group) containing polyester polyurethane resin | 3 | parts by weight |
| [neopentyl glycol/caprolactone polyol/diphenyl methane-4,4′-diisocyanate (MDI) = 0.9/2.6/1 | | |
| (weight ratio), amount of content of —SO₃Na group: 1 × 10⁻⁴ mol/g] | | |
| α-alumina [(particle size: 0.2 μm)] | 5 | parts by weight |
| Carbon black [(particle size: 0.08 μm)] | 0.5 | parts by weight |
| Butyl stearate: | 1 | parts by weight |
| Stearic acid: | 2 | parts by weight |
| Methyl ethyl ketone: | 150 | parts by weight |
| Cyclohexanone: | 50 | parts by weight |
| <Components of nonmagnetic coating material> | | |
| Nonmagnetic pigment: needle shaped α-iron oxide (specific surface area = 53 | 100 | parts by weight |
| m²/g, length of major axis = 0.15 μm, | | |
| needle form ratio = 11) | | |
| Binder: polyvinyl chloride resin | 25 | parts by weight |
| (functional group [—OSO₃K] = 6 × 10⁻⁵ mol/g) | | |
| Antistatic agent: carbon black | 15 | parts by weight |
| (Ketjen Black EC produced by Lion Akzo Co., Ltd.) | | |
| Solvent: methyl ethyl ketone | 150 | parts by weight |
| Solvent: cyclohexanone | 150 | parts by weight |

Then, polyisocyanate (Coronate-L produced by Nippon Polyurethane Industry Co., Ltd.) of 3 parts by weight as a curing agent was added respectively to the magnetic coating material and the nonmagnetic coating material obtained in such a manner as described above. Thus, the magnetic coating material and the nonmagnetic coating material were completed.

Then, the magnetic coating material and the nonmagnetic coating material were simultaneously applied to the nonmagnetic supporter made of polyethylene naphthalate (PEN) (thickness: 6.0 μm, surface roughness of a center line: 5 nm) by using a die coater so that the thickness of the nonmagnetic layer was 2.0 μm after a drying process and the thickness of the magnetic layer thereon was 0.20 μm after the drying process. Then, while both the layers were still in a wet state, an orientation process was carried out by using a cobalt magnet having a magnetic flux density of 0.3 T (3000 gausses) and a solenoid having a magnetic flux density of 0.15 T (1500 gausses). After that, the nonmagnetic layer and the magnetic layer were formed by drying the coating materials.

<Components for forming back coat layer>

| | |
|---|---|
| Carbon black: | 100 parts by weight |
| [average primary particle diameter: | |
| 17 nm, DBP oil absorption: 75 ml/100 g, pH: | |
| 8.0, specific surface area by BET method: | |
| 220 m²/g, volatile part: 1.5%, bulk | |
| density: 15 lbs/ft³] | |
| Nitrocellulose resin | 100 parts by weight |
| Polyester polyurethane resin | 30 parts by weight |
| [(Nipporan produced by Nippon Polyurethane | |
| Industry Co., Ltd)] | |
| Methyl ethyl ketone | 500 parts by weight |
| Toluene: | 500 parts by weight |

The above-described components were preliminarily kneaded by a roll mill. Below described components were added to the obtained dispersed material of 100 parts by weight to disperse them by a sand grinder. The obtained dispersed material was filtered. Then, methyl ethyl ketone of 120 parts by weight and polyisocyanate of 5 parts by weight were added to the dispersed material of 100 parts by weight to prepare coating liquid for forming a back layer.

Subsequently, the coating liquid for forming the back coat layer was applied to the other side of the supporter (opposite side to the magnetic layer) so that the thickness after the drying process was 0.5 μm. The coating liquid was dried to provide the back coat layer and a magnetic recording laminated body roll was obtained in which the nonmagnetic layer and the magnetic layer were provided on one surface of the supporter and the back coast layer was provided on the other surface, respectively.

The obtained magnetic recording laminated body roll was allowed to pass a seven-stage calender processor (temperature of 90° C., linear pressure of 29.4 Mpa (300 kg/cm²)) including only metallic rolls to carry out a calender process. Then, the magnetic recording medium laminated body roll was slit to the width of ½ inches after the calendering process. Further, a grinding and polishing tape (lapping tape) using an abrasive material of a particle diameter of 5 μm was moved in the direction opposite to a tape feed direction (400 m/minute) at a speed of 14.4 cm/minute by a rotating roll and the tape was pressed from an upper part by a guide block. Thus, the grinding and polishing tape was forced to come into contact with the surface of the magnetic layer to carry out a grinding and polishing (lapping) process. The winding tension of the magnetic tape at this time was 100 g and the tension of the lapping tape was 250 g to obtain a sample 1.

### Second Embodiment

### Ferromagnetic Metal Thin Film Medium

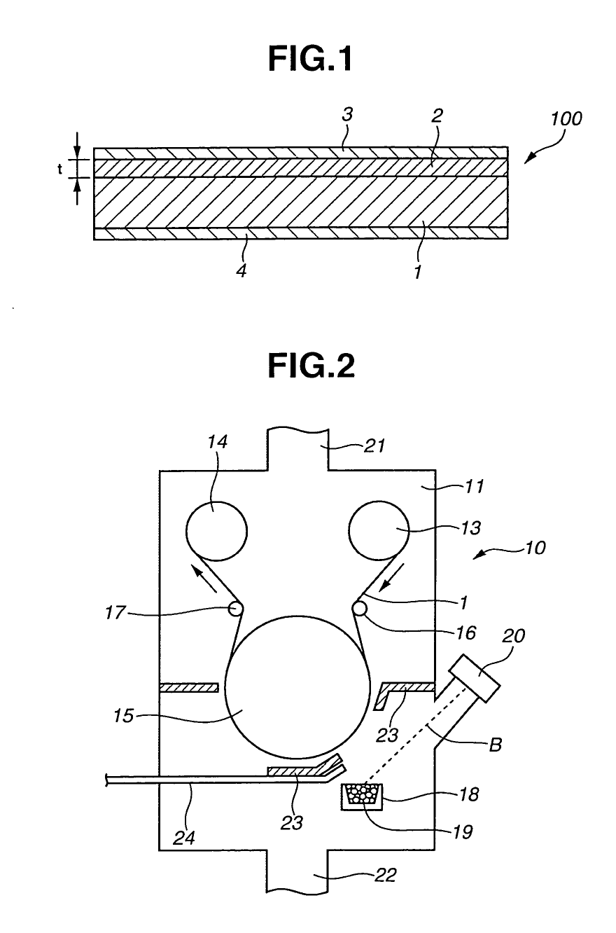

FIG. 1 is a schematic sectional view of an embodiment of a ferromagnetic metal thin film medium. A magnetic recording medium 100 has a structure that a magnetic layer 2 is formed on one main surface of a lengthy nonmagnetic supporter 1 by a vacuum thin film forming technique and a protective layer 3 is sequentially formed on the magnetic layer 2. Reference numeral 4 designates a back coat layer formed on the other main surface of the nonmagnetic supporter 1.

To the nonmagnetic supporter 1, any of known materials that are ordinarily used as base members of the magnetic recording medium may be applied. For instance, exemplified are polyethylene terephthalate, polyethylene naphthalate, polyimide, polyamide, polyether imide, etc.

When the magnetic layer 2 is formed on the nonmagnetic supporter 1 by the vacuum thin film forming technique, the surface property of the nonmagnetic supporter 1 affects the surface property of the magnetic layer 2, and further gives an influence to a C/N or a durability in traveling of the finally obtained magnetic recording medium 100. Accordingly, the surface property of the nonmagnetic supporter needs to be controlled.

Here, in order to obtain the high C/N, the nonmagnetic supporter 1 may select as its surface form a flat surface having protrusions as little as possible and the surface of the magnetic layer 2 may be smoothed. However, when the magnetic layer 2 is excessively smoothed, a friction with a magnetic head is increased. As a result, the traveling characteristics or the durability of the magnetic recording medium 100 are deteriorated. On the other hand, when many protrusions are formed on the surface of the magnetic layer 2, the durability is improved, however, the high C/N can be hardly obtained.

As magnetic metal materials forming the magnetic layer 2, any of the magnetic metal materials that are ordinarily applied to a magnetic tape may be employed. For instance, exemplified are ferromagnetic metals such as Fe, Co, Ni and ferromagnetic alloys such as FeCo, CoNi, CoNiFe, CoCr, CoPt, CoPtB, CoCrPt, CoCrTa, CoCrPtTa, CoNiPt, FeCoNi, FeCoB, FeNiB, FeCoNiCr, etc.

The magnetic layer 2 can be formed to a thin film by the so-called PVD technique such as a vacuum deposition method in which the magnetic metal material is heated and evaporated under vacuum and deposited on the nonmagnetic supporter 1, an ion plating method in which the magnetic metal material is evaporated during a discharge, and a sputtering method in which a glow discharge is generated in an atmosphere having argon as a main component to strike out atoms on the surface of a target by argon ions.

The magnetic layer 2 may be either a single film made of a magnetic metal thin film formed by the above-described method or a multi-layer film. Between the nonmagnetic supporter 1 and the magnetic layer 2, or further, when the magnetic layer 2 is the multi-layer, between the magnetic metal thin films forming the magnetic layer, prescribed base layers or intermediate layers may be provided to improve the adhesion or the coercive force between the respective layers. Further, in the vicinity of the surfaces of the magnetic metal thin films, oxide layers may be formed for the purpose of improving a corrosion resistance.

Especially, when the magnetic layer is used in what is called a linear recording system in which the tape moves on a multi-track head in two ways to record/reproduce data, the magnetic layer 2 has a two-layer structure and an attempt is effective for reducing the difference of the reverse characteristics of electromagnetic transfer characteristics relative to the traveling direction of the tape by making the direction of growth of a column opposite.

FIG. 2 shows a schematic block diagram of one example of a deposition device 10 for forming the film of the magnetic layer 2. In the deposition device 10, a feed roll 13 and a winding roller 14 are provided in a vacuum chamber 11 from which air is exhausted from exhaust ports 21 and 22 to become a vacuum state. The nonmagnetic supporter 1 is sequentially moved between them.

Between the feed roll 13 and the winding roll 14, a cooling can 15 is provided on the way of the movement of the nonmagnetic supporter 1. In the cooling can 15, a cooling device (not shown) is provided to suppress a thermal deformation of the nonmagnetic supporter 1 due to the rise of the temperature.

The nonmagnetic supporter 1 is sequentially fed from the feed roll 13, passes on the peripheral surface of the cooling can 15 and is wound by the winding roll 14. A prescribed tension is exerted on the nonmagnetic supporter 1 by guide rolls 16 and 17 so as to smoothly move the supporter.

In the vacuum chamber 11, a crucible 18 is provided in the lower part of the cooling can 15. The crucible is filled with the magnetic metal material 19. On a side wall part of the vacuum chamber 11, an electron gun 20 is provided for heating and evaporating the magnetic metal material 19 with which the crucible 18 is filled. The electron gun 20 is arranged at such a position as to irradiate the magnetic metal material 19 in the crucible 18 with an electron beam B discharged therefrom. Then, the magnetic metal material 19 evaporated by the irradiation of the electron beam B adheres to the surface of the nonmagnetic supporter 1 to form the magnetic layer 2.

Between the cooling can 15 and the crucible 18 and in the vicinity of the cooling can 15, a shutter 23 is arranged so as to cover a prescribed area of the nonmagnetic supporter 1 moving on the peripheral surface of the cooling can 15. The evaporated magnetic metal material 19 is deposited obliquely within a range of prescribed incident angle relative to the nonmagnetic supporter 1 by the shutter 23.

Further, when the magnetic layer is deposited, oxygen gas is supplied to the surface of the nonmagnetic supporter 1 by an oxygen gas introducing pipe 24 provided and passing through the side wall part of the vacuum chamber 11 to improve the magnetic characteristics, the durability and the weather resistance of the magnetic layer.

On the magnetic layer 2 of the magnetic recording medium 100, the protective layer 3 is formed. The protective layer 3 is preferably formed with carbon as a base material to improve durability and a corrosion resistance.

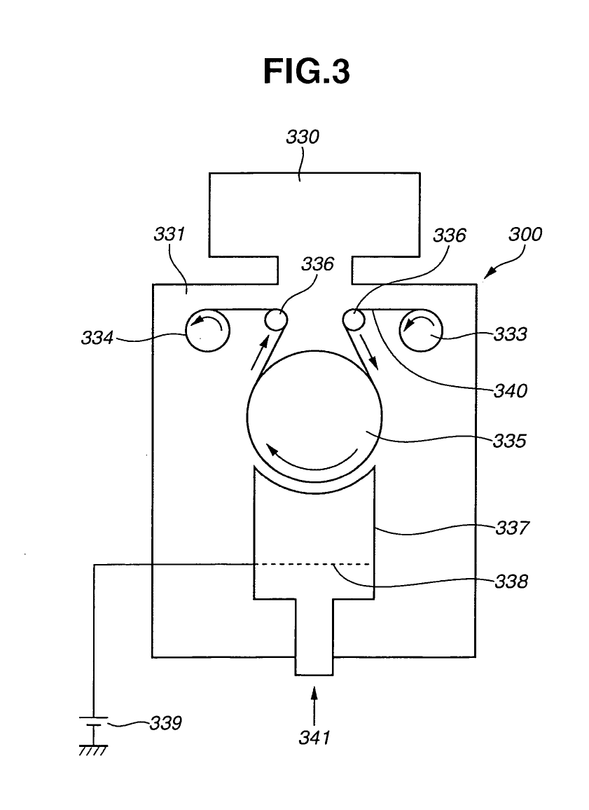

The protective layer 3 can be formed by a known vacuum film forming technique. According to a CVD method for decomposing a carbon compound in plasma to form a film on the magnetic layer 2, for instance, a hard carbon called a diamond-like carbon excellent in abrasion resistance, corrosion resistance and surface coating rate and having a smooth surface form and a high electric resistivity can form a film having the thickness of 10 nm or smaller in a stable way. FIG. 3 shows a schematic block diagram of a plasma CVD continuous film forming device 300 as a film forming device of the protective layer 3.

In this device 300, in a vacuum chamber 331 in which a high vacuum state is established by an exhaust system 330 provided in a head part, a feed roll 333 and a winding roll 334 rotating at fixed speed are provided. The nonmagnetic supporter 1 having the magnetic layer 2 formed, that is, a member 340 to be processed sequentially moves from the feed roll 333 to the winding roll 334.

A can 335 for an opposed electrode is provided on the way where the member 340 to be processed travels from the feed roll 333 to the winding roll 334. The can 335 for the opposed electrode is provided so as to pull out the member 340 to be processed downward in the drawing and rotates clockwise at a fixed speed.

The member 340 to be processed is sequentially fed from the feed roll 333, passes on the peripheral surface of the can 335 for the opposed electrode and is wound by the winding roll 334. Guide rolls 336 are respectively arranged between the feed roll 333 and the can 335 for the opposed electrode, and the can 335 for the opposed electrode and the winding roll 334 so as to exert a prescribed tension on the member 340 to be processed and smoothly move the member 340 to be processed.

In the vacuum chamber 331, a reaction pipe 337 made of pilex (registered trademark) glass, plastic or the like is provided below the can 335 for the opposed electrode. The reaction pipe 337 has one end part passing through the bottom part of the vacuum chamber 331. From this end part, film forming gas is introduced to the reaction pipe 337. Further, to an intermediate part of the reaction pipe 337, an electrode 338 made of metal mesh is attached. The electrode 338 is connected to an externally disposed DC power source 339 and voltage of 500 to 2000 [V] is applied thereto.

In the CVD device, voltage is applied to the electrode 338 so that a glow discharge is generated between the electrode 338 and the can 335 for the opposed electrode. Then, the film forming gas introduced into the reaction pipe 337 is decomposed by the generated glow discharge to cover the member 340 to be processed with the decomposed gas. Thus, the protective layer 3 is formed.

As the carbon compound available for forming the protective layer 3, any of usually known materials such as hydrocarbon, ketone, alcohol or the like may be employed. Further, during producing the plasma, as gas for accelerating the decomposition of the carbon compound, Ar, H₂ or the like ma be introduced.

To improve the hardness of the film and the corrosion resistance of the diamond-like carbon, carbon may in a state that the carbon reacts with nitride and fluorine. The diamond-like carbon film may be composed of a single layer or a multi-layer. Further, during forming the plasma, the film may be formed under a state that not only the carbon compound, but also gas such as N₂, CHF₃, CH₂ F₂ or the like may be independently used or suitably mixed.

When the protective layer 3 is excessively thick, a loss due to spacing is increased. When the protective layer 3 is excessively thin, the abrasion resistance and the corrosion resistance are deteriorated. Accordingly, the protective layer 3 is preferably formed with the thickness of about 4 to 12 [nm].

Further, to the layer forming the protective layer 3, any of layers generally used as the protective layer of the magnetic metal thin film type magnetic recording medium may be applied as well as the above-described carbon layer. For instance, may be exemplified are CrO₃, Al₂O₃, BN, Co oxides, MgO, SiO₂, Si₃O₄, SiN₄, ZrO₂, TiO₂, TiC, etc. The protective layer 3 may be composed of a single layer film or a multi-layer film of them.

To improve traveling characteristics in a recording and reproducing device, the magnetic recording medium 100 according to an embodiment of the present invention may have a back coat layer in an opposite side to a surface on which the magnetic layer 2 is formed. The back coat layer can be formed by a wet application method. In this method, one kind or a plurality of kinds of materials selected from polyurethane based resins, nitrocellulose based resins, polyester based resins (for instance, biron), carbon and calcium carbonate, etc. are dissolved and/or dispersed in a suitable solvent (for instance, a mixed solvent of toluene and methyl ethyl ketone) to prepare coating liquid. The coating liquid is applied to a surface of the nonmagnetic supporter 1 opposite to a surface on which the magnetic layer is formed, and then, dried to evaporate the solvent. When the back coat layer is formed in such a way, the thickness of the back coat layer is preferably set to 100 to 500 nm.

(Sample 2)

In this embodiment, as the nonmagnetic supporter 1 of the magnetic recording medium 100 shown in FIG. 1, polyethylene naphthalate having the thickness of 7.5 [μm] and the width of 150 [mm] was prepared. On the surface of the nonmagnetic supporter 1, fine protrusions were formed. The density of the protrusions having the height of 20 [nm] or higher was 2.3 [piece/μm²].

Now, the magnetic layer 2 was formed on the nonmagnetic supporter 1 according to the following conditions.

(Film forming conditions)

| | |
|---|---|
| Ingot: | Co 100 (wt %) |
| Incident angle: | 45° to 10° |
| Introducing gas: | oxygen gas |
| Amount of introduction of oxygen gas: | 3.3 × 10⁻⁶ [m³/sec] |
| Degree of vacuum upon deposition: | 2.0 × 10⁻² [Pa] |
| Thickness of magnetic layer (t): | 50 [nm] |

Then, the diamond-like carbon protective layer 3 was formed on the magnetic layer 2 by the plasma CVD method in accordance with below-described film forming conditions.

(Film forming conditions)

| | |
|---|---|
| Reaction gas: | toluene |
| Reaction gas pressure: | 10 [Pa] |
| Introducing power: | DC 1.5 kV |
| Thickness of protective layer: | 10 [nm] |

Then, a coating material composed of carbon and a urethane resin was applied to a main surface opposite to the surface on which the magnetic layer 2 was formed to form a back coat layer 4 having the thickness of 0.5 [μm]. Subsequently, perfluoropolyether based lubricant was applied to the magnetic surface to form a magnetic tape and slit the magnetic tape to ½ inch width as a sample 2.

### EXAMPLES OF THE INVENTION

Now, specific [Examples] and [Comparative examples] of the magnetic recording medium 100 of the present invention will be described. The magnetic recording medium of the present invention is not limited to the following examples.

### Example 1

In the sample 1, a texture was formed on the back coat layer in parallel with a traveling direction by the use of a grinding and polishing tape (lapping tape).

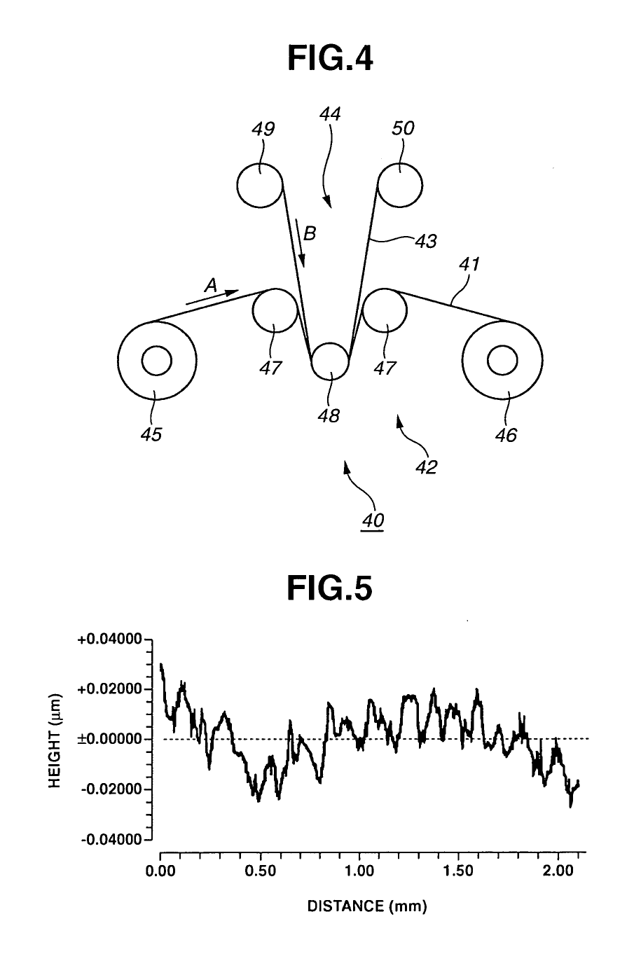

FIG. 4 shows one example of a surface grinder and polisher for forming the texture on the back coat layer. A member to be processed (magnetic tape) 41 is moved between a feed roll 45 and a winding roll 46 in a direction A through guide rolls 47 and 47 at a speed, for instance, 400 m/minute (a traveling system 42 of a member to be processed).

Then, a grinding and polishing tape (lapping tape) 43 using an abrasive material having a particle diameter of 9 μm was moved in a direction B (the same as the direction A) between a feed roll 49 and a winding roll 50 through a pressing roll 48 at a speed, for instance, 14.4 cm/minute (a grinding and polishing tape traveling system 44). The pressing roll 48 was forced to press the surface of the back coat layer side of the member to be processed) 41 from an upper part by a guide block. Thus, the grinding and polishing tape 43 was allowed to come into contact with the surface of the back coat layer, so that a grinding and polishing (lapping) process was carried out. At this time, the winding tension of the magnetic tape was 100 g and the tension of the lapping tape was 250 g.

FIG. 5 shows a surface scanning form of a media in which the texture is formed on the back coat layer. The surface scanning form was measured in accordance with a scanning white light interferometry by a general purpose three dimensional surface structure analyzer New View 5020 produced by ZYGO Corporation under the conditions of measured area of 2.8 mm×2.11 μm, objective lens of 2.5 times and zoom magnification of 1.0 times). An evaluation was carried out after a cylinder was corrected by turning off a filter.

A horizontal axis shows a scanning operation in the direction of width of the tape substantially over 2 mm. A vertical axis shows irregularities on the surface. As apparent from FIG. 5, large waviness is recognized with 40 nm at cycles of about 1.5 mm. Further, small irregularities of 20 nm are recognized at cycles of about 110 μm. The large and small waviness continuously occur in the longitudinal direction of the tape.

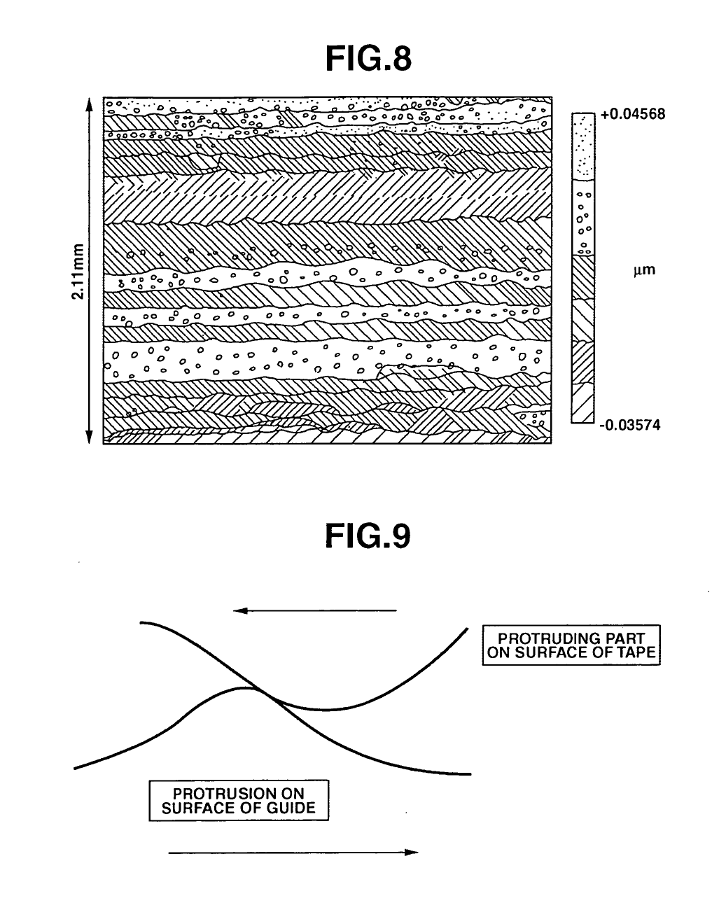

FIG. 8 shows the irregularities on the surface of the tape. FIG. 5 shows a sectional form in the transverse direction of FIG. 8. An area depicted by a dotted line shows a protrusion (maximum value: 0.04568 μm). An area shown by oblique lines inclined rightward designates a bottom (minimum value: −0.03574 μm). A horizontal direction of FIG. 5 shows the direction of width of the tape. As recognized from FIG. 5, the large and small waviness continuously appear in the longitudinal direction of the tape.

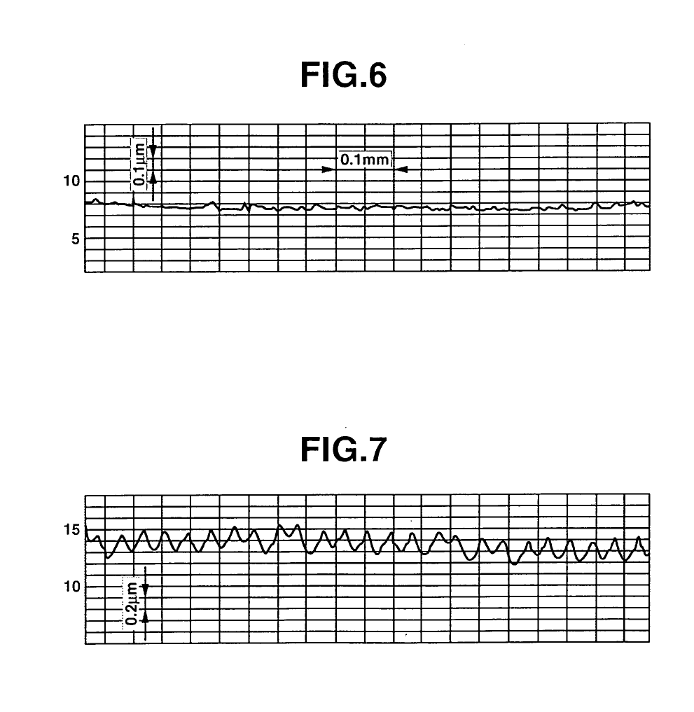

FIGS. 6 and 7 show surface properties of a tape traveling surface of a drive side on which the tape moves. Each of horizontal axes shows the direction of width of the tape. A tape guide member always comes into contact with a part of the surface of the tape, or comes into contact therewith with a certain probability. Accordingly, it is important to select the guide member that does not damage the surface of the tape or the surface property thereof. For instance, as the guide member, a guide member is devised that is formed with aluminum having crystal particles of silicon deposited or mixed as base metal.

The surface property is shown in FIG. 7 when the guide member is surface finished by a turning tool of an ordinary lathe having an end of an R shape. As easily understood from FIG. 7, protrusions caused by feed of the turning tool are formed and end parts thereof seriously damage to the surface of the tape.

On the other hand, FIG. 6 shows the surface property when a guide surface is formed by a turning tool for a ultra-precision finished surface whose end is formed to a special form. As easily understood from FIG. 6, protrusions that damage the tape are rarely formed. Accordingly, when the tape is repeatedly moved by the use of the guide having this surface property, problems do not arise.

The magnetic recording medium according to an embodiment of the present invention wherein the protruding parts of the waviness on the surface of the tape formed in the direction of width of the tape come into contact with protruding parts of the fine waviness formed on the surface of the guide in the tape traveling direction to cause a frictional force by which an LTM in the direction of width of the tape is regulated.

The contact between the protruding parts of the waviness on the surface of the tape and the protruding parts of the fine waviness on the surface of the guide is the same as that in the longitudinal direction from the view point of contact area of the tape. In a mechanism for generating the frictional force as shown in FIG. 9, the protruding part of the tape and the protruding part of the guide respectively bite into recessed parts of the other parties as illustrated. Thus, a reaction force of a component in a moving direction is considered to be a part or a substantial part of the frictional force.

However, as easily understood from FIG. 8, the protruding parts in the longitudinal direction of the tape have the same height and the waviness is continuously formed. Accordingly, the bite as shown in FIG. 9 is hardly generated in the longitudinal direction of the tape. As the frictional force, the generation of stickiness, intermolecular force and electrostatic force may be considered. However, the force is greatly smaller than a physical contact force and has no directional anisotropy.

As can be understood from FIG. 5, since the cycle of the large waviness is 1.5 mm, about 8 protruding parts are formed, for instance, in the tape of width of 12.65 mm. However, when the tension of the tape is exerted in the longitudinal direction of the tape, the large waviness is flattened, and the fine protruding parts at the cycles of 110 μm come into contact with the surface of the guide. The number of contacts in the direction of width of the tape is equal to 12.65 mm/0.11 mm=115 parts. Accordingly, as the feature of the invention, the probability of generation of the bites of the tape and the guide member respectively is increased and the elevation of the frictional force is adequately anticipated.

When an amount of air supplied from an external part is large, or in a guide system of a dynamic pressure bearing in which a relative speed is high, an amount of floatation of the tape considerably exceeds a value as the sum of the peak value of 20 to 40 nm of the irregularities of the tape and the surface roughness of the guide of 100 nm. Thus, the solid contact of the protruding parts on the surface of the tape with the protruding parts on the surface of the guide according to an embodiment of the present invention is decreased in view of probability and the effect of the present invention is lowered.

As compared therewith, for example, when the present invention is applied to a dynamic pressure bearing device in which an amount of floatation of air is controlled by a slot (groove) formed in the guide to raise a coefficient of friction between the surface of the tape and the slide surface of the guide, an effect thereof is large.

Namely, in the structure of the device, a groove is formed in a position of a bearing guide opposed to a magnetic head and an edge line of the guide slide surface in the groove is formed to be sharp, so that an air boundary layer on the surface of the tape is separated during moving the magnetic tape to reduce air pressure between the surface of the tape and the slide surface of the guide to cause a negative pressure.

According to this structure, the coefficient of friction between the magnetic tape near the groove and the slide surface of the guide is increased to suppress variation in the direction of width of the magnetic tape. At this time, when a magnetic tape according to an embodiment of the present invention is used as the magnetic tape, the coefficient of friction is increased and the probability of the above-described solid contact of the protruding parts on the surface of the tape with the protruding parts on the slide surface of the guide is increased, so that the LTM effect can be sufficiently realized.

### Example 2

The tape was manufactured in the same manner as that of the Example 1 except that the lapping tape having the particle diameter of 5 μm was used.

### Example 3

The tape was manufactured in the same manner as that of the Example 1 except that the lapping tape having the particle diameter of 16 μm was used.

### Example 4

The tape was manufactured in the same manner as that of the Example 1 except that the lapping tape having the particle diameter of 30 μm was used.

### Example 5

The tape was manufactured in the same manner as that of the Example 1 except that the lapping tape having the particle diameter of 57 μm was used.

### Example 6

The tape was manufactured in the same manner as that of the Example 1 except that the sample 2 was used in place of the sample 1.

### Example 7

The tape was manufactured in the same manner as that of the Example 6 except that the lapping tape having the particle diameter of 5 μm was used.

### Example 8

The tape was manufactured in the same manner as that of the Example 6 except that the lapping tape having the particle diameter of 16 μm was used.

### Example 9

The tape was manufactured in the same manner as that of the Example 6 except that the lapping tape having the particle diameter of 30 μm was used.

### Example 10

The tape was manufactured in the same manner as that of the Example 6 except that the lapping tape having the particle diameter of 57 μm was used.

### Comparative Example 1

The sample 1 was directly used to manufacture a sample having no texture.

### Comparative Example 2

The tape was manufactured in the same manner as that of the Example 1 except that the lapping tape having the particle diameter of 3 μm was used.

### Comparative Example 3

The tape was manufactured in the same manner as that of the Example 1 except that the lapping tape having the particle diameter of 80 μm was used.

### Comparative Example 4

The sample 2 was directly used to manufacture a sample having no texture.

### Comparative Example 5

The tape was manufactured in the same manner as that of the Comparative example 3 except that the lapping tape having the particle diameter of 80 μm was used.

### Comparative Example 6

The tape was manufactured in the same manner as that of the Comparative example 3 except that the lapping tape having the particle diameter of 80 μm was used.

For the magnetic tapes of the samples of Examples 1 to 10 and Comparative examples 1 to 6 manufactured as described above respectively, the LTM and tracking error standard deviation were evaluated.

In the evaluation, a dynamic pressure air bearing system generated by a relative speed between the tape and the traveling surface of the guide was used as a tape traveling system and the surface form of the guide was configured so as to have a form shown in FIG. 6. The speed of the tape was 8 m/s. A servo signal was written in the tape and the tracking error standard deviation was measured. At this time, the samples having the tracking error standard deviation of 0.2 or lower were determined to be successful.

Further, an output and a C/N ratio when wavelength λ was 0.25 μm were measured. The C/N ratio was obtained from a noise level separated by 1 MHz from a central frequency. The output and the C/N ratio were respectively standardized by determining the Example 1 as 0 dB in the sample 1 and the Example 6 as 0 dB in the sample 2. Obtained results are shown in Table 1.

TABLE 1

| | Depth of texture | Cycle of texture | LTM |
|---|---|---|---|
| | (nm) | (μm) | (μm) |
| Example 1 | 20 | 110 | 4.9 |
| Example 2 | 15 | 25 | 5.8 |
| Example 3 | 120 | 240 | 5.1 |
| Example 4 | 260 | 370 | 5.3 |
| Example 5 | 380 | 500 | 5.8 |
| Example 6 | 22 | 110 | 5.0 |
| Example 7 | 16 | 25 | 5.9 |
| Example 8 | 140 | 240 | 5.2 |
| Example 9 | 280 | 370 | 5.4 |
| Example 10 | 400 | 500 | 5.9 |
| Comparative | 10 (none) | none | 11.0 |
| example 1 | | | |
| Comparative | 10 | 15 | 10.0 |
| example 2 | | | |
| Comparative | 600 | 750 | 6.2 |
| example 3 | | | |
| Comparative | 11 (none) | none | 12.0 |
| example 4 | | | |
| Comparative | 11 | 15 | 11.0 |
| example 5 | | | |
| Comparative | 650 | 750 | 6.5 |
| example 6 | | | |

| | Tracking error | | |
|---|---|---|---|
| | standard deviation | Output | C/N |
| | (μm) | (dB) | (dB) |
| Example 1 | 0.13 | 0.0 | 0.0 |
| Example 2 | 0.19 | 0.1 | 0.0 |
| Example 3 | 0.15 | −0.1 | −0.1 |
| Example 4 | 0.17 | −0.2 | −0.2 |
| Example 5 | 0.19 | −0.3 | −0.4 |
| Example 6 | 0.13 | 0.0 | 0.0 |
| Example 7 | 0.19 | 0.1 | 0.1 |
| Example 8 | 0.15 | −0.1 | −0.1 |
| Example 9 | 0.17 | −0.2 | −0.2 |
| Example 10 | 0.19 | −0.3 | −0.4 |
| Comparative | 0.26 | 0.1 | 0.0 |
| example 1 | | | |
| Comparative | 0.25 | 0.0 | 0.0 |
| example 2 | | | |
| Comparative | 0.21 | −1.0 | −1.1 |
| example 3 | | | |
| Comparative | 0.27 | 0.1 | 0.1 |
| example 4 | | | |
| Comparative | 0.26 | 0.0 | 0.0 |
| example 5 | | | |
| Comparative | 0.22 | −1.0 | −2.0 |
| example 6 | | | |

In the Table 1, the tracking error standard deviation greatly affects the quality of a servo and 0.2 or lower is suitable. In the Comparative examples 1 and 3, it is supposed that the texture on the surface of the back coat is low, so that an amount of involved air is increased, a widthwise suppressing force does not function and the LTM and the tracking error standard deviation are increased.

Further, in the Comparative examples 2 and 4, both the output and the C/N ratio are deteriorated and lower than −1 as a threshold value. It is supposed that the deterioration of the surface property on the back of the a media is transferred in the forms to the magnetic surface to lower these values. As shown in the Table 1, it is recognized that in the magnetic tapes of the Examples 1 to 10, an LTM suppressing effect due to the formation of the texture is seen and an electromagnetic transfer characteristics are not badly affected.

It should be understood by those skilled in the art that various modifications, combinations, sub-combinations and alterations may occur depending on design requirements and other factors insofar as they are within the scope of the appended claims or the equivalents thereof.

What is claimed is:

1. A magnetic recording medium used for a linear recording system comprising:
a magnetic layer on one main surface of a lengthy nonmagnetic supporter and
a back coat layer including at least inorganic solid particles and a binder on the other main surface opposite to the magnetic layer forming surface, wherein a texture is provided on the back coat layer in parallel with a traveling direction.

2. The magnetic recording medium according to claim 1, wherein the depth of the texture is 15 to 400 nm.

3. The magnetic recording medium according to claim 1, wherein the cycle of the texture in the direction of width of the medium is 25 to 500 (μm).

4. The magnetic recording medium according to claim 2, wherein the cycle of the texture in the direction of width of the medium is 25 to 500 (μm).

5. The magnetic recording medium according to claim 1, wherein the magnetic recording medium is a particulate type magnetic recording medium in which the magnetic layer is manufactured by applying and drying a magnetic coating material obtained by dispersing a magnetic material such as magnetic powder in an organic binder.

6. The magnetic recording medium according to claim 2, wherein the magnetic recording medium is a particulate type magnetic recording medium in which the magnetic layer is manufactured by applying and drying a magnetic coating material obtained by dispersing a magnetic material such as magnetic powder in an organic binder.

7. The magnetic recording medium according to claim 3, wherein the magnetic recording medium is a particulate type magnetic recording medium in which the magnetic layer is manufactured by applying and drying a magnetic coating material obtained by dispersing a magnetic material such as magnetic powder in an organic binder.

8. The magnetic recording medium according to claim 4, wherein the magnetic recording medium is a particulate type magnetic recording medium in which the magnetic layer is manufactured by applying and drying a magnetic coating material obtained by dispersing a magnetic material such as magnetic powder in an organic binder.

9. The magnetic recording medium according to claim 1, wherein the magnetic layer is a ferromagnetic metal thin film formed by allowing the nonmagnetic supporter to be directly coated with a ferromagnetic material made of metal of an alloy of Co—Ni by plating or a vacuum thin film forming technique.

10. The magnetic recording medium according to claim 2, wherein the magnetic layer is a ferromagnetic metal thin film formed by allowing the nonmagnetic supporter to be directly coated with a ferromagnetic material made of metal of an alloy of Co—Ni by plating or a vacuum thin film forming technique.

11. The magnetic recording medium according to claim 3, wherein the magnetic layer is a ferromagnetic metal thin film formed by allowing the nonmagnetic supporter to be directly coated with a ferromagnetic material made of metal of an alloy of Co—Ni by plating or a vacuum thin film forming technique.

12. The magnetic recording medium according to claim 4, wherein the magnetic layer is a ferromagnetic metal thin film formed by allowing the nonmagnetic supporter to be directly coated with a ferromagnetic material made of metal of an alloy of Co—Ni by plating or a vacuum thin film forming technique.
